(19) United States
(12) Patent Application Publication
(10) Pub. No.: US 2001/0035512 A1
(43) Pub. Date: Nov. 1, 2001

(54) Environmentally friendly electro-pneumatic positioner

(76) Inventors: Jeffrey M. Messer, Wheaton, IL (US); John M. Messer, Charleston, IL (US)

Correspondence Address: JENKENS & GILCHRIST, P.C., 1445 ROSS AVENUE. SUITE 3200, DALLAS,, TX, 75202-2799, US

(21) Appl. No.: 09/813,269

(22) Filed: Mar. 20, 2001

Related U.S. Application Data
(60) Provisional application No. 60/195,699, filed on Apr. 7, 2000.

(51) Int. Cl. F16K 31/02

(52) U.S. Cl. 251/129.04; 700/282

(57) ABSTRACT

An electro-pneumatic positioner is disclosed. The positioner has a pair of solenoids for precise positioning a flow control valve. This positioner is computer controlled, provides a high-resolution continuous positioning with no bleed of gas or fluid. It also provides a fail-safe open, closed, or as-is positioning mode and a pulse mode positioning to prevent inertial overshooting of the target position of the flow control valve.

### CROSS REFERENCE

This application claims the benefits of a Provisional Application entitled “Environmentally Friendly Electro-Pneumatic Positioner” filed on Apr. 7, 2000 having a serial number of 60/195,699.

### BACKGROUND OF THE INVENTION

The present invention relates generally to valve positioning devices in fluid control systems, and more particularly, to a system and apparatus for an environmentally friendly electro-pneumatic valve positioner.

The flow of fluids (gas or liquid) through fluid control pipelines is controlled by a multitude of valves which direct and control the magnitude of fluid flow within the network of pipes. Additionally, these control valves must control and maintain the pressure within the pipeline network within a precise range, requiring that the valves be positioned within certain exacting tolerances.

Many conventional valves achieve flow control by using a pneumatic positioner. A common pneumatic positioner may use a current-to-pressure (I/P) transducer/controller module with a 4-20 mA input. Sometimes the I/P module is packaged within the electro-pneumatic positioner.

A major problem with these types of valves is the continuous bleed of fluid produced by the I/P module. Depending on the fluid, this bleed can be expensive, toxic, or explosive. As a result, these types of valves are not environmentally friendly.

What is needed is a precise, highly positional, electro-pneumatic fluid valve control system with no continuous bleed of fluid/gas.

### SUMMARY OF THE INVENTION

An environmentally friendly electro-pneumatic positioner system is disclosed. The system controls a position of a main control valve for passing a predetermined type of fluid. It includes components such as a pressure driven pneumatic actuator which alters the position of the main control valve, a control logic module which operates the actuator based on an actual position and a desired position of the main control valve, and a solenoid valve module for interfacing the control logic module with the pneumatic actuator. The control logic module has a responsive continuous feedback signal for accurately indicating the desired position of the main control valve.

One example of the present invention uses a pair of solenoids in the solenoid module to control the pressure applied to the actuator of the main control valve. The solenoids work in tandem with a position transmitter via an electro-pneumatic positioner (EFP) in order to position a main control valve precisely.

The current invention allows the valve to be pre-set for “open”, “closed”, or “as-is” in the event of signal failure. It has a pulse generator for moving each solenoid step-wise towards its target position, thus eliminating inertial movement past the desired position. Moreover, in one example of the present invention, a solenoid cycle counter is used as an indication of the service life of the solenoid valve module.

In another example of the present invention, a finer control of gas/fluid flow in a pipeline is presented. In this example, two or more EFPs may be used, which splits a signal from a position transmitter that indicates the actual position of the main control valve.

In another example of the present invention, a single acting flow control valve is used for a low supply pressure configuration with a spring return actuator.

In one example of the present invention, two solenoids of the solenoid module is separately located, one for opening the actuator, and the other for closing the actuator.

In yet another example of the present invention, a pressure control override feature is integrated with other features described above.

### BRIEF DESCRIPTION OF THE DRAWINGS

FIG. 1 illustrates a schematic for a flow control system having an environmentally friendly electro-pneumatic positioner (EFP) integrated therein according to one embodiment of the present invention.

FIG. 2 illustrates a logic diagram for the EFP of FIG. 1.

FIG. 3 shows detailed electronic circuit diagram for the EFP of FIG. 1.

FIG. 4 illustrates a schematic for another embodiment of the present invention using a single acting flow control valve with a spring return actuator.

FIG. 5 illustrates a schematic for another embodiment of the present invention in which the solenoid module is separately located, one for opening the actuator, and the other for closing the actuator.

FIG. 6 is a block diagram 70 illustrating a system configuration for a conventional flow control with pressure control override.

FIG. 7 is a schematic illustrating a configuration of a double acting flow control valve with pressure control override according to one example of the present invention.

FIG. 8 is a schematic illustrating a single acting control valve with pressure control override configuration directed more particularly to a low supply pressure configuration according to one example of the present invention.

FIG. 9 is a schematic illustrating a single acting control valve with pressure control override configuration directed more particularly to a high supply pressure configuration.

### DESCRIPTION OF THE PREFERRED EMBODIMENT

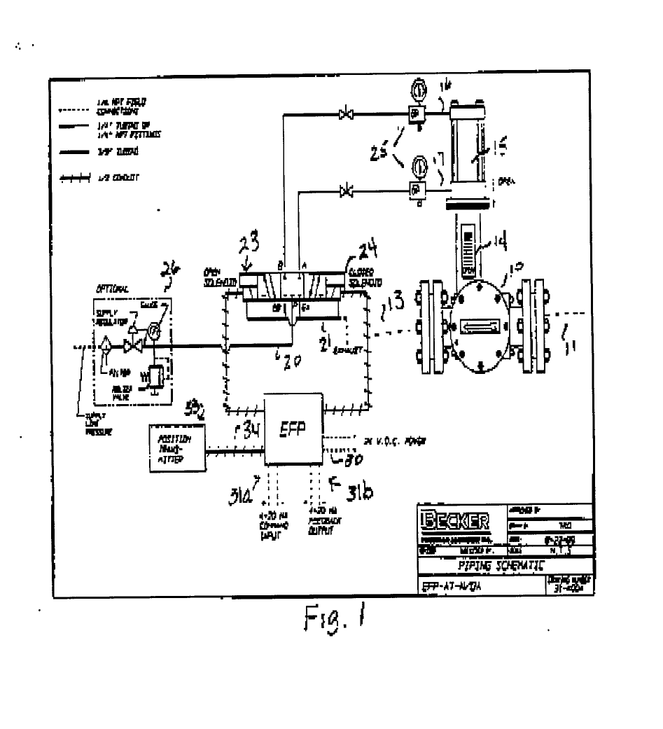

Referring now to FIG. 1, a flow control system 5 includes a main control valve 10. For the sake of example, the main control valve 10 is a large ball valve connectable within a fluid (e.g. natural gas) supply line is one of the key control device components for controlling the flow in the direction of arrow F. The main control valve 10 controls flow from a high pressure side 11 to a downstream lower pressure side 13 by regulating the size of the valve opening. To vary the size of the valve opening, a rod within housing 14 is movable vertically by connecting to a piston captured within a cylinder 15. The cylinder 15 can also be referred to as an actuator. Upper and lower natural gas pressure lines 16 and 17 supply pressure above and below the piston to move it in the direction of the lesser of the two pressures.

To supply an actuating pressure in lines 16 and 17, a three-position solenoid valve 18 of a solenoid module is connected between a high pressure supply line 20 and an exhaust line 21. In operation, the solenoid valve 18 is shifted, for example, from a neutral central position (with all internal ports of the solenoid valve blocked against flow) to the right by an “open solenoid” 23. This connects the high pressure line 20 to upper cylinder line 16 delivering high pressure to the upper chamber of the piston cylinder driving the piston downwardly to move the main control valve 10 in an opening direction. By shifting the solenoid valve 18 in the opposite direction from the neutral position, a “closed solenoid” 24 which functions in the same manner as the open solenoid 23 connects the high pressure supply line 20 to the lower line 17 for driving the piston upwardly in a valve closing direction. The ports in the solenoid valve 18 may connect the lower line 17 with the exhaust line 21.

Within each of the lines 16 and 17 is a variable orifice 25 which may be adjusted manually to control the rate of fluid flow into and out of the upper and lower cylinder chambers on opposite sides of the piston. As the orifices 25 are adjusted larger, the fluid flows more quickly into and out of the cylinder chambers increasing the speed at which the actuator operates. As the orifices 25 are adjusted smaller, the fluid flow is slower thereby decreasing the overshoot of the main control valve 10 as it reaches a target setting.

One configuration for providing the high pressure supply for the line 20 is to connect the high pressure side 11 of the main control valve 10 through a regulator 26, providing a clean, steady and dry power/pressure source. When the pressure drop across the main control valve 10 is sufficient, the exhaust fluid from the solenoid valve may be vented into the low pressure line 13, thereby avoiding the release of any gas into the atmosphere. The exhaust fluid may also be released into a second pressure system of sufficiently low pressure.

An environmentally friendly electro-pneumatic positioner (EFP) 30 controls movements of the solenoid valve 18 by directing an electrical power to either of the solenoids 23 and 24. When connected to a valve position controller, a signal 31a from the controller (an “input signal”) provides a logic board of the EFP with an indication of the desired position of the main control valve 10. A position transmitter 33 connected between the main control valve 10 and the logic board provides a signal 34 indicating the actual position of the main control valve 10. Both the signal provided by the position transmitter 33 and the input signal 31a are small current signals, typically in the range of 4-20 mA. The desired position for the main control valve 10 is compared to the actual position and, if different, the solenoid valve 18 is actuated to cause movement of the piston to drive the main control valve 10 from the actual position towards the desired position. The EFP 30 also outputs a continuous or nearly continuous position feedback signal 31b to the valve position controller so that the position of the main control valve can be updated. Under normal circumstances, the EFP 30 can position the actuator no better than the resolution of the feedback signal. In a conventional product in the industry, 100 increments for the feedback signal is fairly large to implement, but still not sufficient to “fine tune” the solenoid. In one example of the present invention, a continuous analogue feedback is implemented so that a true continuous feedback is obtainable. In another example of the present invention, it is contemplated that a large number of digital feedback signal increments are used. For instance, 2¹⁰ (or 1024) or more increments within the 20 mA span of the feedback signal 31b will allow for 1024 increments (or less) of the positioning process. One objective of the present invention is to use this nearly-continuous (digital) or continuous (analogue) feedback signal in conjunction with the solenoid valve 18 to create a responsive, yet non-bleeding electro-pneumatic positioner.

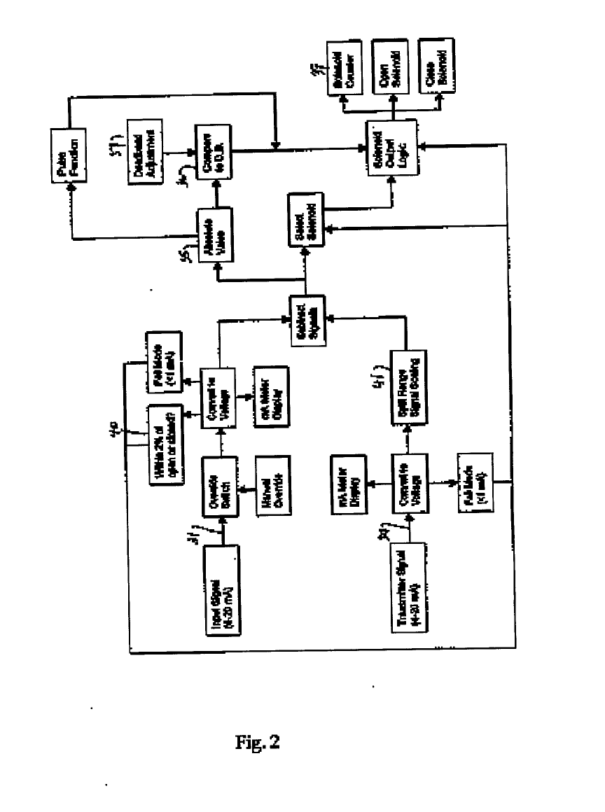

Now referring to FIG. 2, an EFP method is used to avoid the problem of dithering (oscillating between two close points) of the main control valve 10 about a target position. In block 35, an absolute value of the difference in the signal 31a (representing the actual position of the main control valve) and the input signal 31b is compared to a dead-band value. The result is identified as a percent of a value representing the full travel of the main control valve 10 (at block 36). If it is within this dead-band value, then neither solenoid is actuated and the solenoid valve 18 remains in its current position, and the movement of the main control valve ceases. In one example of the present invention, the deadband value is adjustable at block 37 (e.g., from 0.1% to 2%). The greater the percentage, the more stable the main control valve 10 positions, and as the percentage becomes smaller, the more sensitive the main control valve becomes. Moreover, an end travel bias (40) is also used to provide for full pressure directing the main control valve toward an adjacent position of either fully closed or fully open when the input signal is within a fixed percentage (e.g., two percent) of either of those positions. Henceforth, the current invention allows for the determination of a “fail safe” in either of three selected positions, i.e., “as is,” “open,” or “closed” in the event loss of the input signal 31a or the signal 34 from the position transmitter.

Also provided is a pulse function control (block 38) for avoiding overshooting of a target position for the main control valve 10. Within a specified range of the target position, instead of providing a continuous power signal to the appropriate solenoid, a pulse signal is generated so that only a pulse of high pressure is directed to the appropriate side of the piston. This “pulse function” effectively slows down the speed of the main control valve 10 as it approaches the desired position. In other words, as long as the position of the main control valve 10 is far from the desired position, the solenoid valve will be turned on completely; however, as the main control valve 10 gets close to the desired position, the solenoid valve will pulse on and off at a speed optimized for the particular solenoid valve in use. The optimized speed can be preprogrammed based on the material characteristics of the main control valve 10. Consequently, instead of driving the main control valve 10 to pass its target position, the main control valve 10 is moved in pulse steps toward the target position.

When the main control valve 10 is in a desired position, that is, when the actuator is not moving, all ports of the solenoid valve are blocked and there is zero bleed gas from the system. When the pneumatic actuator (cylinder) is at the end of its stroke, holding the main control valve 10 completely open or closed, the solenoid valve is shifted, but full pressure has equalized on one side of the actuator, while atmospheric pressure or exhaust backpressure has equalized on the other side of the actuator. Therefore, the main control valve 10 can sit in a fully open or fully closed condition with no bleed gas from the electro-pneumatic positioner system.

Another advantage to using a solenoid valve over a current-to-pressure (I/P) transducer is that the exhaust from the actuator can be discharged through the solenoids to a lower pressure system. The exhaust may be dumped as gas/fluid towards the downstream, or it may be received by a separate lowpressure system, which happens to be in close proximity to the electropneumatic positioner.

The current invention also includes the use of a solenoid counter (block 39) as an indication of service life. The solenoid counter is a diagnostic tool, which allows the user to schedule solenoid valve maintenance before the solenoid accumulates excess wear. Every time the solenoid is triggered to operate by the EFP, the solenoid counter is incremented. If a predetermined number of cycles have been executed, the solenoid can be rebuilt or replaced prior to its failure.

Finally, for a finer control of gas flow in a line, two or more EFPs may be used to work with signals split from the signal 31a. The general idea is to have multiple EFPs to control and respond to a signal in a sub-range within, for example, 4-20 mA. In one example, there are two EFPs, two position transmitters, and two main control valves. The first set of components containing one EFP, one position transmitter, and a main control valve act over 4-12 mA, and similarly, the other set over 12-20 mA.

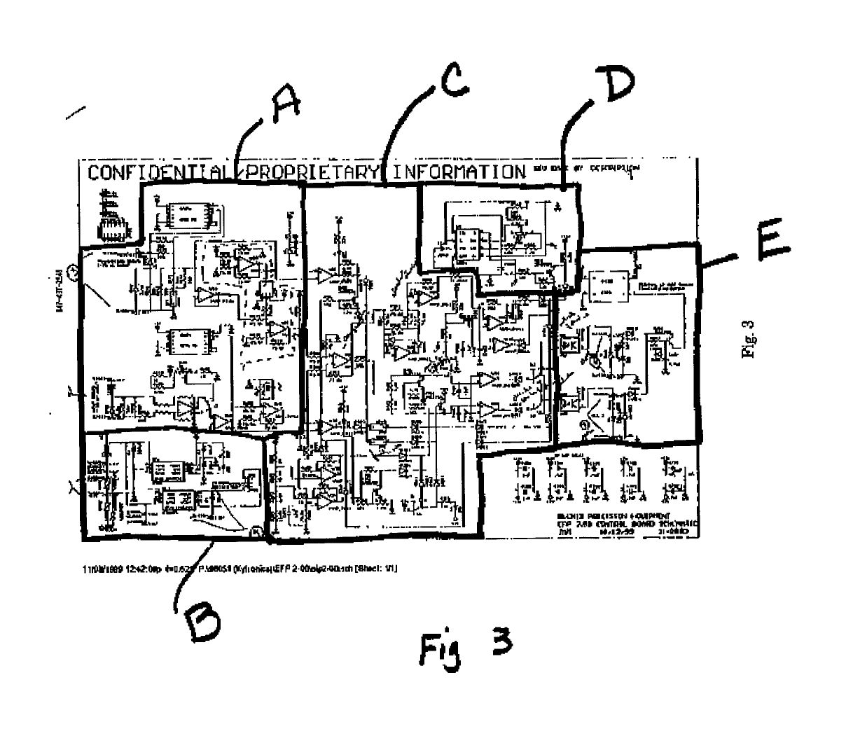

Referring to FIG. 3, one embodiment of the EFP 30 of FIG. 1 includes various circuit modules, separated by function. For example, block A contains input signals, signal conditioning, and input signal meters, block B is for power supply and management, block C is the logic for controlling the solenoid, block D is a pulse function generator, and block E is the solenoid power output and cycle counter.

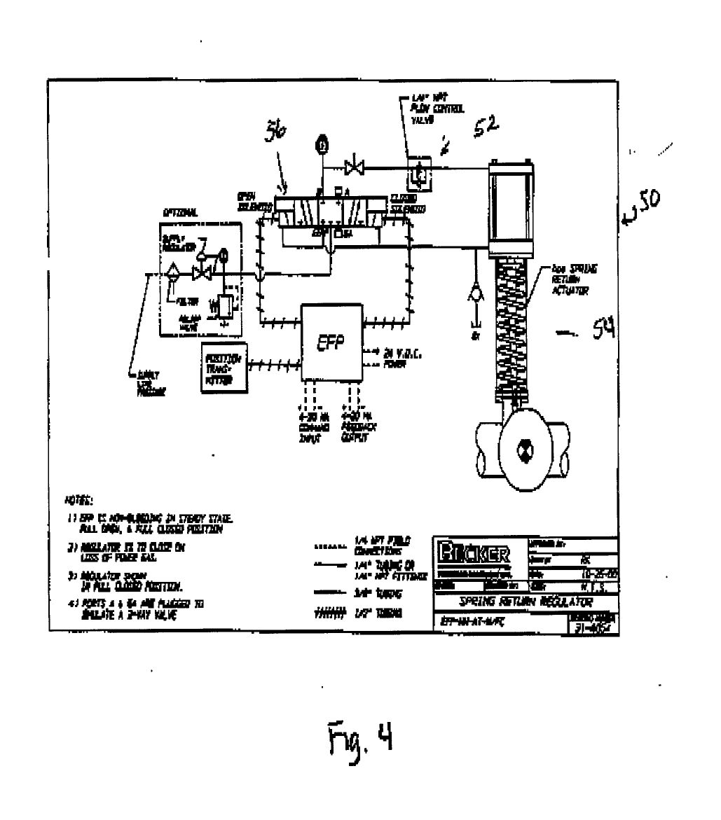

Referring now to FIG. 4, another embodiment of the EFP is identified with the reference numeral 50. The EFP 50 uses a single acting flow control valve 52 with a spring return actuator 54. In this embodiment, the single acting flow control 52 is connected between port B of the solenoid module 56 and the upper part of the actuator 54, and the lower half of the actuator is connected to the exhaust system. Port A and EA are actually sealed because there is no need to feed the actuator with a pressure to push the cylinder back since the spring in the actuator will function the same.

Another variation of the present invention is to connect the single acting flow control valve 52 between port EB of the solenoid module and the exhaust system. In this configuration, there will be no restriction when a pressure is provided to push the cylinder down, but by controlling the exhaust of the cylinder, the speed of the cylinder is regulated.

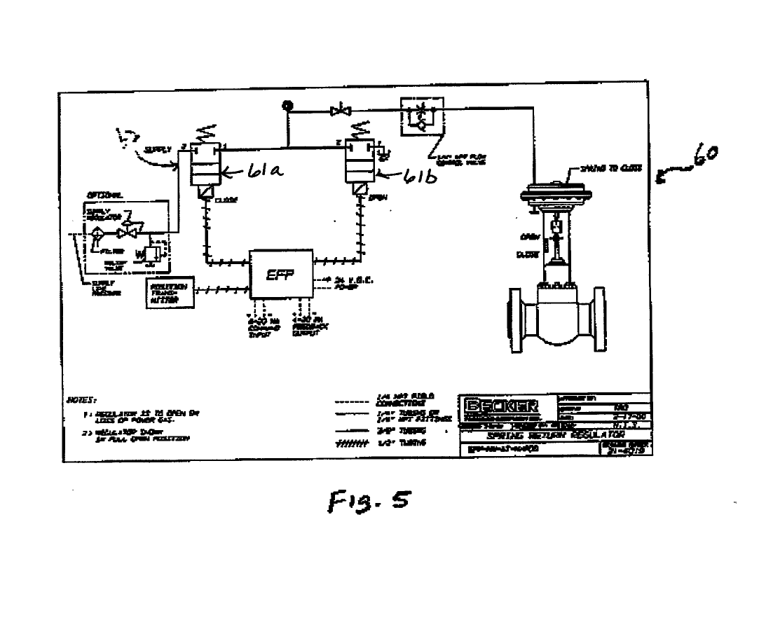

Referring further to FIG. 5, another embodiment of the EFP is identified with the reference numeral 60. As shown, the solenoid module is separately located, one (61a) for opening the actuator, and the other (61b) for closing the actuator. In this embodiment, the supply pressure 62 should be around 40 psig.

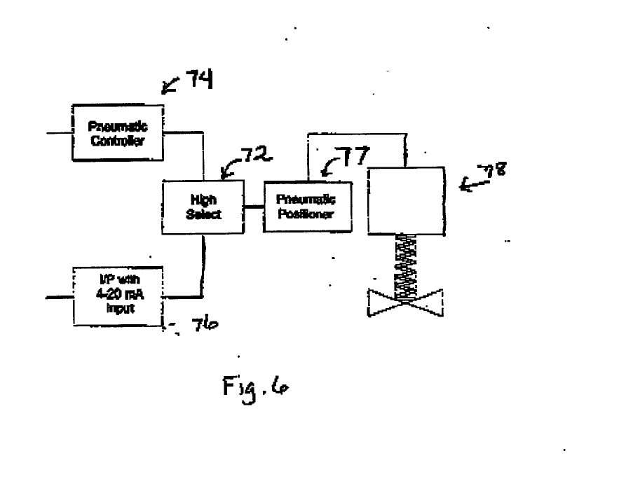

Further referring to FIG. 6, in a conventional configuration for flow control with pressure control override, a high selector relay 72 compares the inputs from both a pneumatic controller 74 and an input signal from an I/P 76, and determines which signal should control the pneumatic positioner 77 which further drives the actuator 78. According to one example of the present invention, by using an EFP, the pneumatic positioner 77 can be eliminated.

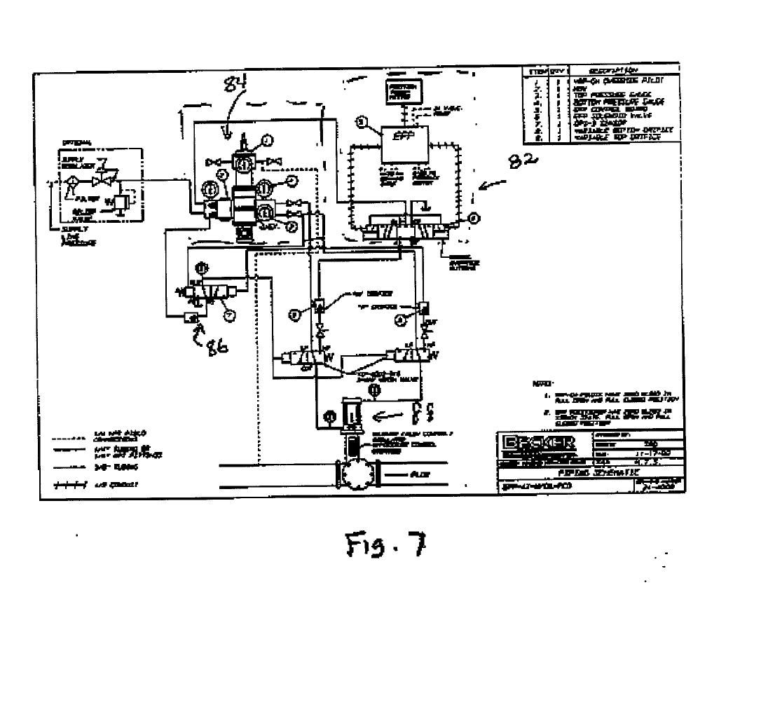

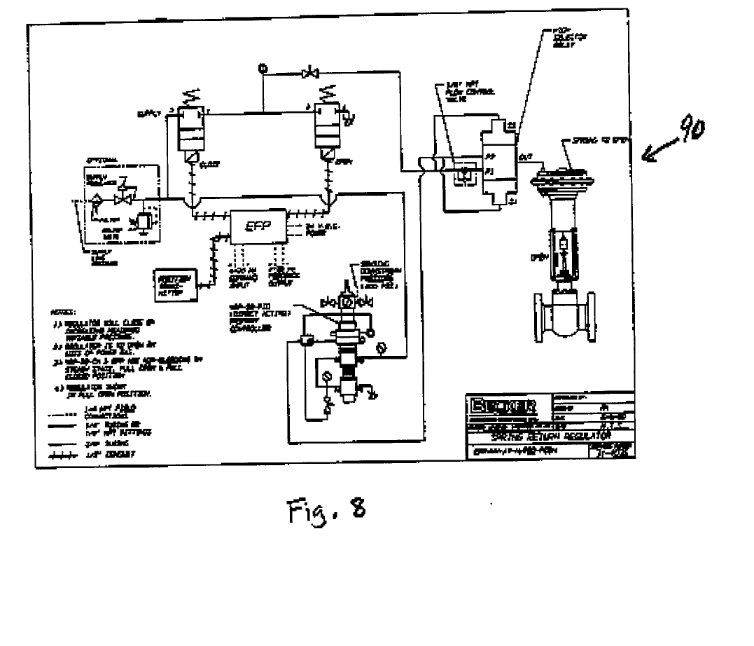

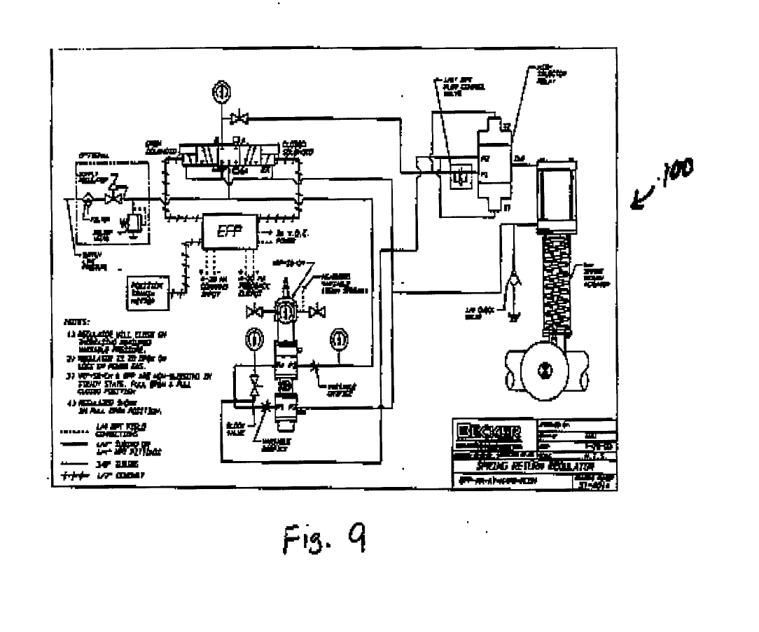

Referring to FIG. 7, according to one example of the present invention, the EFP module 82 and a pilot module 84 both feed inputs to a high selector relay 86, the output of which controls the actuator 88. The high selector relay 86 basically selects the input having a higher value. For example, if the pilot module detects the downstream pipe pressure of the main control valve is less than a predetermined value such as 400 psig, the pilot signal will be less than another predetermined value such as 3 psig (or virtually 0 psig), and the EFP will be controlling the behavior of the actuator since it would produce a signal larger than 0 or 3 psig. On the contrary, if the downstream pipe pressure exceeds 400 psig, the pressure control override feature initiates, and controls the behavior of the actuator. FIG. 8 and FIG. 9 are two different schematics 90 and 100 illustrating two single acting control valve with pressure control override configurations, with FIG. 8 directed to low supply pressure configuration and FIG. 9 for a high supply pressure configuration.

The present invention enjoys various advantages. By using the solenoid valve to control the actuator pressures, the EFP eliminates the continuous bleed gas produced by I/P transducers, and bleeds no gas until the main control valve is called upon to move. Further, the EFP is capable of falling in its last position on a loss of signal or DC power.

The above disclosure provides many different embodiments, or examples, for implementing different features of the invention. Also, specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention.

What is claimed is:

1. An electro-pneumatic positioner system for controlling a position of a main control valve, the system comprising:
a pressure driven pneumatic actuator which alters the position of the main control valve;
a control logic module which operates the actuator based on an actual position and a desired position of the main control valve; and
a solenoid valve module for interfacing the control logic module with the pneumatic actuator,
wherein the control logic module has a responsive continuous feedback signal for indicating more accurately the desired position of the main control valve, and
wherein the main control valve is either positioned as fully open or fully closed condition.

2. The system of claim 1 wherein all ports of the solenoid valve module are blocked when the actuator is not moving so that no bleed fluid is generated.

3. The system of claim 1 wherein the control logic module compares a first electrical signal from a valve position transmitter indicating the actual position of the main control valve with a second electrical signal from a valve position controller indicating the desired position of the main control valve.

4. The system of claim 1 wherein the electro-pneumatic positioner system further comprises a solenoid counter, the solenoid counter measuring a predetermined operation life of a solenoid valve of the solenoid valve module.

5. The system of claim 4 wherein the solenoid counter increments its count each time when the solenoid valve is triggered.

6. The system of claim 1 wherein the control logic module controls the solenoid valve module to slow down and pulse at an optimized speed when the main control valve is close to a predetermined position within a predetermined range.

7. The system of claim 6 wherein the optimized speed is determined based on material characteristics of the main control valve.

8. The system of claim 6 wherein the continuous responsive feedback signal provides a continuous number of indications of the actual location of the main control valve for further adjusting the position thereof.

9. The system of claim 1 wherein the actuator discharges its exhaust through the solenoid valve module to a lower pressure system.

10. An electro-pneumatic positioner system for controlling a position of a main flow control valve to adjust a predetermined fluid flow, the system comprising:
a pressure driven pneumatic actuator which alters the position of the main flow control valve;
a control logic module which operates the actuator by comparing a first electrical signal from a valve position transmitter indicating an actual position of the main control valve with a second electrical signal from a valve position controller indicating an expected location of the main control valve, the control logic module including a responsive feedback signal enhancing the accuracy of the second electrical signal; and
a solenoid valve module for interfacing the control logic with the pneumatic actuator,
wherein the main control valve is either positioned as fully open or fully closed condition.

11. The system of claim 10 wherein all ports of the solenoid valve module are blocked when the actuator is not moving so that no bleed fluid is generated.

12. The system of claim 10 wherein the electro-pneumatic positioner system further comprising a solenoid counter, the solenoid counter measuring a predetermined operation life of a solenoid valve of the solenoid valve module.

13. The system of claim 12 wherein the solenoid counter increments its count each time when the solenoid valve is triggered.

14. The system of claim 10 wherein the control logic module controls the solenoid valve module to slow down and pulse at an optimized speed when the main control valve is close to a predetermined position within a predetermined range.

15. The system of claim 14 wherein the optimized speed is determined based on material characteristics of the main control valve.

16. The system of claim 10 wherein the responsive feedback signal is an analogue feedback signal.

17. The system of claim 10 wherein the responsive feedback signal is a digital feedback signal with a high resolution.

18. The system of claim 10 wherein the actuator discharges its exhaust through the solenoid valve module to a lower pressure system.

19. The system of claim 10 wherein the solenoid valve module contains two separately positioned solenoids, one for controlling the actuator to open the main control valve and another for controlling the actuator to close the main control valve.

20. The system of claim 10 wherein a first acting flow control valve is positioned between the solenoid valve module and the upper part of the actuator, the first acting flow control valve restricting a pressure injecting to the upper half of the actuator, and a second acting flow control valve is positioned between the solenoid valve module and the lower part of the actuator, the second acting flow valve restricting a pressure injecting to the lower half of the actuator.

21. The system of claim 10 wherein an acting flow valve is situated between the lower half of the actuator and the solenoid valve module restricting an outgoing exhaust flow from the actuator while no such restriction is imposed for the upper half of the actuator.

22. The system of claim 10 wherein the actuator is a return spring actuator.

23. The system of claim 10 further comprising a pressure control override module which controls movements of the main control valve if the pressure of a downstream pipe from the main control valve exceeds a predetermined value.
